(19) United States
(12) Patent Application Publication
(10) Pub. No.: US 2013/0295831 A1
(43) Pub. Date: Nov. 7, 2013

(54) METHOD FOR CONTROLLING AN AIRCRAFT AIR CONDITIONING SYSTEM DURING MAINTENANCE

(71) Applicant: AIRBUS OPERATIONS GMBH, Hamburg (DE)

(72) Inventors: Jurgen KELNHOFER, Jork (DE); Dariusz KRAKOWSKI, Buxtehude (DE)

(21) Appl. No.: 13/852,586

(22) Filed: Mar. 28, 2013

Related U.S. Application Data
(60) Provisional application No. 61/619,963, filed on Apr. 4, 2012.

(30) Foreign Application Priority Data
Apr. 4, 2012 (EP) 12163190.7

(51) Int. Cl. B64D 13/06

(52) U.S. Cl. CPC B64D 13/06
USPC 454/76

(57) ABSTRACT

In a method for controlling an aircraft air conditioning system, during normal operation of the aircraft, the supply of conditioned air from the aircraft air conditioning system to an aircraft region to be air conditioned is controlled such that the conditioned air is evenly distributed in the aircraft region to be air conditioned. During a predetermined operational phase of the aircraft, the supply of conditioned air from the aircraft air conditioning system to the aircraft region to be air conditioned is controlled such that the conditioned air is distributed only in a selected portion of the aircraft region to be air conditioned.

### CROSS REFERENCE TO RELATED APPLICATIONS

This application is entitled to and claims the benefit of European Application No. 12163190.7 filed Apr. 4, 2012 and U.S. Provisional Application No. 61/619,963, filed Apr. 4, 2012, the disclosures of each of which, including the specification, claims, drawings and abstract, are incorporated herein by reference in their entirety.

### FIELD

The present invention relates to a method for controlling an aircraft air conditioning system during a predetermined operational phase of the aircraft, in particular during maintenance, and to an aircraft air conditioning system.

### BACKGROUND

So-called air-based air conditioning systems, as described for example in DE 10 2008 053 320 A1 or non-published DE 10 2010 054 448, are usually used at present in commercial aircraft to air-condition the aircraft cabin. An aircraft air conditioning system serves to cool the aircraft cabin, which would otherwise be overheated due to thermal loads, such as, for example, body heat of the passengers and waste heat from equipment present on board the aircraft. The aircraft air conditioning system in addition adequately supplies fresh air into the aircraft cabin to ensure that a prescribed minimum proportion of oxygen is present in the aircraft cabin.

Air-based air conditioning systems typically comprise an air conditioning unit, which is arranged, for example, in a wing root of the aircraft, and which is supplied with compressed process air that is generated by a compressor or bled of from an engine or an auxiliary power unit (APU) of the aircraft. During flight operation of the aircraft, usually engine bleed air is used so as to supply the air conditioning unit of the aircraft air conditioning system with compressed process air. During ground operation of the aircraft the air conditioning unit of the aircraft air conditioning system, however, typically is supplied with compressed process air from the auxiliary power unit of the aircraft. In the air conditioning unit, the process air, upon flowing through at least one heat exchanger as well as through various compression and expansion units, is cooled and expanded. Cooled process air exiting the air conditioning unit finally is supplied to a mixing chamber where it is mixed with recirculation recirculated from an aircraft region to be air conditioned. The mixed air from the mixing chamber, via respective mixed air lines, is supplied to the aircraft region to be air conditioned which may be divided into a plurality of air conditioning zones.

### SUMMARY

The present application is directed at the object of specifying a method for controlling an aircraft air conditioning system that during a predetermined operational phase of the aircraft, in particular during maintenance, allows a particularly energy efficient operation of the aircraft air conditioning system. Further, the invention is directed at the object of providing an aircraft air condition system that during a predetermined operational phase of the aircraft, in particular during maintenance, may be operated in a particularly energy-efficient manner.

This object is achieved by a method for controlling an aircraft air conditioning system having features of attached claims and an aircraft air conditioning system having features of attached claims.

In a method, according to this application, for controlling an aircraft air conditioning system, during normal operation of the aircraft, the supply of conditioned air from the aircraft air conditioning system to an aircraft region to be air conditioned is controlled such that the conditioned air is evenly distributed in the aircraft region to be air conditioned. The aircraft region to be air conditioned may be an aircraft passenger cabin, a cockpit, a freight compartment or any other aircraft region. Specifically, the expression “normal operation of the aircraft” in the context of the present application designates an operational state of the aircraft, wherein heat has to be dissipated from heat sources that are substantially evenly distributed in the aircraft region to be air conditioned. In case the aircraft region to be air conditioned is a passenger cabin of the aircraft, the expression “normal operation of the aircraft”, for example, designates an operational state of the aircraft wherein the passenger cabin is occupied with passengers.

When the conditioned air, during normal operation of the aircraft, is evenly distributed in the aircraft region to be air conditioned, the aircraft region to be air conditioned is evenly heated or cooled, as desired. In particular, a substantially even temperature distribution in the aircraft region to be air conditioned is achieved. During normal operation of the aircraft, an even distribution of conditioned air in the aircraft region to be air conditioned provides comfortable conditions in the aircraft region to be air conditioned, while simultaneously ensuring a sufficient dissipation of heat from thermal loads present in the aircraft region to be air conditioned.

During a predetermined operational phase of the aircraft, the supply of conditioned air from the aircraft air conditioning system to the aircraft region to be air conditioned is controlled such that the distribution of the conditioned air is concentrated to a selected portion of the aircraft region to be air conditioned. In other words, during the predetermined operational phase of the aircraft, the supply of conditioned air from the aircraft air conditioning system to the aircraft region to be air conditioned is controlled such that the conditioned air is no longer evenly distributed in the aircraft region to be air conditioned, but concentrated to the selected portion of the aircraft region to be air conditioned. Of course, in particular since the selected portion of the aircraft region to be air conditioned and a remaining portion of the aircraft region to be air conditioned may not be physically separated from each other also during the predetermined operational phase of the aircraft, the supply of conditioned air may not be exclusively limited to the selected portion of the aircraft region to be air conditioned. Instead, a limited flow of conditioned air may also enter the remaining portion of the aircraft region to be air conditioned.

However, during the predetermined operational phase of the aircraft a significant concentration of conditioned air in the selected portion of the aircraft region to be air conditioned is achieved by appropriately controlling the supply of the conditioned air into the aircraft region to be air conditioned. The concentration of the distribution of conditioned air to the selected portion of the aircraft region to be air conditioned may be detected, for example, by supplying visible smoke together with the conditioned air of instead of the conditioned air into the aircraft region to be air conditioned. Further, measurements of the temperature distribution in the aircraft region to be air conditioned may be used to verify the concentration of the distribution of conditioned air to the selected portion of the aircraft region to be air conditioned.

The method for controlling an aircraft air conditioning system, during normal operation of the aircraft allows a high air conditioning comfort to be achieved in the entire aircraft region to be air conditioned. During the predetermined operational phase of the aircraft, the air conditioning performance of the aircraft air conditioning system is concentrated to the selected portion of the aircraft region to be air conditioned. Preferably, the selected portion of the aircraft region to be air conditioned is a portion of the aircraft region to be air conditioned which during the predetermined operational phase has a higher air conditioning demand than the remaining portion of the aircraft region to be air conditioned.

Hence, during the predetermined operational phase of the aircraft, the air conditioning demand required to be provided by the aircraft air conditioning system can be reduced as compared to the air conditioning demand required to be provided by the aircraft air conditioning system during normal operation of the aircraft, while still ensuring that the selected portion of the aircraft region to be air conditioned is sufficiently air conditioned. As a result, the performance requirements placed on a compressed air source, such as e.g. an engine or an auxiliary power unit of the aircraft, which supplies compressed air to an air conditioning unit of the aircraft air conditioning system can be reduced. Hence, fuel consumption and wear of the compressed air source can be reduced.

Basically, the predetermined operational phase of the aircraft may be any operational phase of the aircraft during which it is not necessary or not desired to evenly air condition the entire aircraft region to be air conditioned. Preferably, however, the predetermined operational phase of the aircraft is a maintenance operational phase of the aircraft during which maintenance or service work may be performed or the aircraft may be cleaned. During a maintenance operational phase of the aircraft the air conditioning requirement typically is concentrated to only selected portions of the aircraft region to be air conditioned. Specifically, during a maintenance operational phase of the aircraft, the air conditioning requirement typically is limited to an aisle region of the aircraft region to be air conditioned. The selected portion of the aircraft region to be air conditioned thus preferably comprises an aisle region of the aircraft region to be air conditioned.

The control of the supply of conditioned air from the aircraft air conditioning system to the aircraft region to be air conditioned during the predetermined operational phase of the aircraft may be initiated in response to a signal indicative of the start of the predetermined operational phase of the aircraft. The signal indicative of the start of the predetermined operational phase of the aircraft may be a signal that is output to the aircraft air conditioning system in response to a manual input by a user. For example, the maintenance or cleaning crew may operate a switch so as to induce the output of a signal to the aircraft air conditioning system which indicates the start of a maintenance operational phase of the aircraft. Alternatively or additionally thereto, selected operating parameters of the aircraft may be monitored so as to determine, e.g. by means of a suitable software logic, whether the predetermined operational phase of the aircraft has started. Suitable operating parameters of the aircraft which may be used for determining whether the predetermined operational phase of the aircraft has started, are, e.g., parameters indicating a ground operation of the aircraft while a passenger cabin of the aircraft is not occupied with passengers.

In the method for controlling an aircraft air conditioning system conditioned air preferably is supplied to the aircraft region to be air conditioned via air inlets which are arranged in a ceiling region of the aircraft region to be air conditioned. Preferably, the air inlets are adapted to eject conditioned air substantially in a direction of a central region of the aircraft region to be air conditioned. For example the air inlets may be arranged in a ceiling region of an aircraft passenger cabin along a longitudinal axis of the aircraft passenger cabin. The air inlets may be adapted to eject conditioned air substantially in a direction of an aisle region of the aircraft region to be air conditioned and/or a direction of a portion of the aircraft region to be air conditioned which is disposed above rows of passenger seats arranged in the aircraft passenger cabin.

Air may be discharged from the aircraft region to be air conditioned via air outlets which are arranged in a floor region of the aircraft region to be air conditioned. The air outlets may be provided directly in a floor of the aircraft region to be air conditioned or in portion of side walls of the aircraft region to be air conditioned which is disposed adjacent to a floor of the aircraft region to be air conditioned.

Basically, the concentration of the distribution of the conditioned air to the selected portion of the aircraft region to be air conditioned, during the predetermined operational phase of the aircraft, may be achieved by suitably controlling the air inlets through which conditioned air is supplied to the aircraft region to be air conditioned. For example, the air inlets could be controlled such that only selected air inlets eject conditioned air into the aircraft region to be air conditioned. Alternatively or additionally thereto, in the method for controlling an aircraft air conditioning system the distribution of conditioned air in the aircraft region to be air conditioned may be controlled by appropriately controlling the speed at which the conditioned air is supplied to the aircraft region to be air conditioned through the air inlets.

During normal operation of the aircraft the conditioned air preferably is supplied to the aircraft region to be air conditioned with a high impulse and at a high speed. Owing to the high impulse and the high speed of the conditioned air, tumble air movements form in the aircraft region to be air conditioned which ensure a virtual homogeneous intermixing of the conditioned air with the ambient air, wherein free convection induced by heat sources and cold or hot surfaces is dominated by the forced flow of the tumble air movements. Due to the tumble air movements the conditioned air is evenly distributed in the aircraft region to be air conditioned. This operating principle of an aircraft air conditioning system involving the formation of forced tumble air movements is also known as the so-called mixed ventilation principle. Specifically, conditioned air which is blown into an aircraft passenger cabin through air inlets which are arranged in a ceiling region of the aircraft is evenly distributed in an aisle region and also a passenger seat region of the aircraft passenger cabin.

By reducing the speed and thus the impulse of the air blown into the aircraft region to be air conditioned through the air inlets, the formation of tumble air movements which provide for an even distribution of the conditioned air in the aircraft region to be air conditioned is limited or even prevented, Hence, the distribution of the air supplied to the aircraft region to be air conditioned is concentrated to a selected portion of the aircraft region to be air conditioned, for example an aisle region of an aircraft passenger cabin.

During normal operation of the aircraft conditioned air preferably is supplied to the aircraft region to be air conditioned at a speed of approx. 1.5 to 2.5 m/s and with a high impulse so as to ensure the formation of tumble air movements which provide for an even distribution of the conditioned air in the aircraft region to be air conditioned. The injection speed of the conditioned air may vary in dependence on a distance of an air inlet through which conditioned air is injected into the aircraft region to be air conditioned from a passenger seat. In particular, the injection speed of the conditioned air should be the lower, the closer an air inlet through which the conditioned air is injected is disposed to a passenger seat so as to ensure that the air conditioning comfort of a passenger sitting on the passenger seat is not affected.

During the predetermined operational phase of the aircraft conditioned air may be supplied to the aircraft region to be air conditioned at a speed of approx. 0.5 to 1.0 m/s and with a lower impulse. By injecting the conditioned air into the aircraft region to be air conditioned at that reduced speed, the formation of tumble air movements is limited or prevented such that the distribution of the conditioned air is concentrated to the selected portion of the aircraft region to be air conditioned.

Further, if desired, the distribution of the conditioned air in the aircraft region to be air conditioned may be controlled by appropriately controlling an injection angle at which the conditioned air is injected into the aircraft region to be air conditioned. The injection angle of the conditioned air may, e.g., be controlled by appropriately controlling a position and orientation of the air inlets through which the conditioned air is supplied to the aircraft region to be air conditioned. For example, if the distribution of the conditioned air should be concentrated to an aisle region of an aircraft passenger cabin, the injection angle of the conditioned air may be controlled such that the conditioned air is injected in the direction of the aisle region of the passenger cabin.

Further, during the predetermined operational phase of the aircraft, a lower amount of conditioned air may be supplied to the aircraft region to be air conditioned than during normal operation of the aircraft. A reduction of the amount of conditioned air supplied to the aircraft region to be air conditioned may be achieved, e.g., by reducing an amount of recirculation air supplied to a mixing chamber of the aircraft air conditioning system from the aircraft region to be air conditioned, e.g., by appropriately reducing the speed of recirculation fans conveying recirculation air from the aircraft region to be air conditioned to the mixing chamber of the aircraft air conditioning system. Alternatively or additionally thereto, the amount of fresh air provided by an air conditioning unit of the air conditioning system to the mixing chamber may be reduced.

Further, during the predetermined operational phase of the aircraft, conditioned air may be supplied to the aircraft region to be air conditioned at a lower temperature than during normal operation of the aircraft. This may be achieved, e.g., by reducing the percentage of typically relatively warm recirculation air in the mixing chamber of the aircraft air conditioning system. Alternatively or additionally thereto, a temperature of the fresh air supplied to the mixing chamber from the air conditioning unit of the aircraft air conditioning system may be reduced. During normal operation of the aircraft the temperature of the conditioned air supplied to the aircraft region to be air conditioned should not fall below a predetermined threshold value so as to ensure a high air conditioning comfort in the aircraft region to be air conditioned.

During a maintenance operational phase of the aircraft it is, however, not necessary that these comfort requirements are met. Therefore, it is possible to more efficiently use the cooling performance capacity of the air conditioning unit of the aircraft air conditioning system, while simultaneously keeping the demand of compressed air to be provided by the compressed air source low.

During the predetermined operational phase of the aircraft the supply of conditioned air to the aircraft region to be air conditioned may be controlled in dependence on the air conditioning state in the selected portion of the aircraft region to be air conditioned. For example, signals provided by suitable sensors, such as temperature sensors or pressure sensors disposed in the selected portion of the aircraft region to be air conditioned, may be used upon controlling the supply of conditioned air to the aircraft region to be air conditioned. This allows a reliable control of the air conditioning state in the selected portion of the aircraft region to be air conditioned.

An aircraft air conditioning system, according to this application, comprises a control unit which is adapted to, during normal operation of the aircraft, control the supply of conditioned air from the aircraft air conditioning system to an aircraft region to be air conditioned such that the conditioned air is evenly distributed in the aircraft region to be air conditioned and, during a predetermined operational phase of the aircraft, control the supply of conditioned air from the aircraft air conditioning system to the aircraft region to be air conditioned such that the distribution of the conditioned air is concentrated to a selected portion of the aircraft region to be air conditioned.

The predetermined operational phase of the aircraft may be a maintenance operational phase of the aircraft. The selected portion of the aircraft region to be air conditioned may be an aisle region of the aircraft region to be air conditioned.

The control unit may be adapted to initiate the control of the supply of conditioned air from the aircraft air conditioning system to the aircraft region to be air conditioned during the predetermined operational phase of the aircraft in response to a signal indicative of the start of the predetermined operational phase of the aircraft. The signal indicative of the start of the predetermined operational phase of the aircraft may be output to the aircraft air conditioning system in response to a manual input by a user. Alternatively or additionally thereto, the signal indicative of the start of the predetermined operational phase of the aircraft may be output to the aircraft air conditioning system in response to the detection of selected operating parameters of the aircraft.

The aircraft air conditioning system preferably further comprises air inlets for supplying conditioned air to the aircraft region to be air conditioned. The air inlets may be arranged in a ceiling region of the aircraft region to be air conditioned. Further, the air inlets may be adapted to eject conditioned air substantially in a direction of a central region of the aircraft region to be air conditioned.

Further, the aircraft air conditioning system may comprise air outlets for discharging air from the aircraft region to be air conditioned. The air outlets may be arranged in a floor region of the aircraft region to be air conditioned.

The control unit may be adapted to control the supply of conditioned air to the aircraft region to be air conditioned such that, during the predetermined operational phase of the aircraft, the conditioned air is supplied to the aircraft region to be air conditioned at a lower speed than during normal operation of the aircraft.

In particular, the control unit may be adapted to control the supply of conditioned air to the aircraft region to be air conditioned such that, during normal operation of the aircraft, conditioned air is supplied to the aircraft region to be air conditioned at a speed of approx. 1.5 to 2.5 m/s, and such that, during the predetermined operational phase of the aircraft, conditioned air is supplied to the aircraft region to be air conditioned at a speed of approx. 0.5 to 1.5 m/s.

The control unit may be adapted to control the supply of conditioned air to the aircraft region to be air conditioned such that during the predetermined operational phase of the aircraft, a lower amount of conditioned air is supplied to the aircraft region to be air conditioned than during normal operation of the aircraft.

Further, the control unit may be adapted to control the supply of conditioned air to the aircraft region to be air conditioned such that, during the predetermined operational phase of the aircraft, conditioned air is supplied to the aircraft region to be air conditioned at a lower temperature than during normal operation of the aircraft.

Finally, the control unit may be adapted to control the supply of conditioned air to the aircraft region to be air conditioned, during the predetermined operational phase of the aircraft, in dependence on the air conditioning state in the selected portion of the aircraft region to be air conditioned.

### BRIEF DESCRIPTION OF THE DRAWINGS

A preferred embodiment of the application in the following will be described in more detail with reference to the appended schematic drawings, in which

FIG. 1 shows an aircraft air conditioning system which is supplied with compressed fresh air by means of an auxiliary power unit,

FIG. 2 shows a detail of the aircraft air conditioning system according to FIG. 1,

FIG. 3 shows an air distribution system of the aircraft air conditioning system according to FIG. 1,

FIG. 4 shows the distribution of conditioned air which is provided by the aircraft air conditioning system according to FIG. 1 and injected into an aircraft passenger cabin during normal operation of the aircraft, and

FIG. 5 shows the distribution of conditioned air which is provided by the aircraft air conditioning system according to FIG. 1 and injected into an aircraft passenger cabin during normal operation of the aircraft

### DETAILED DESCRIPTION

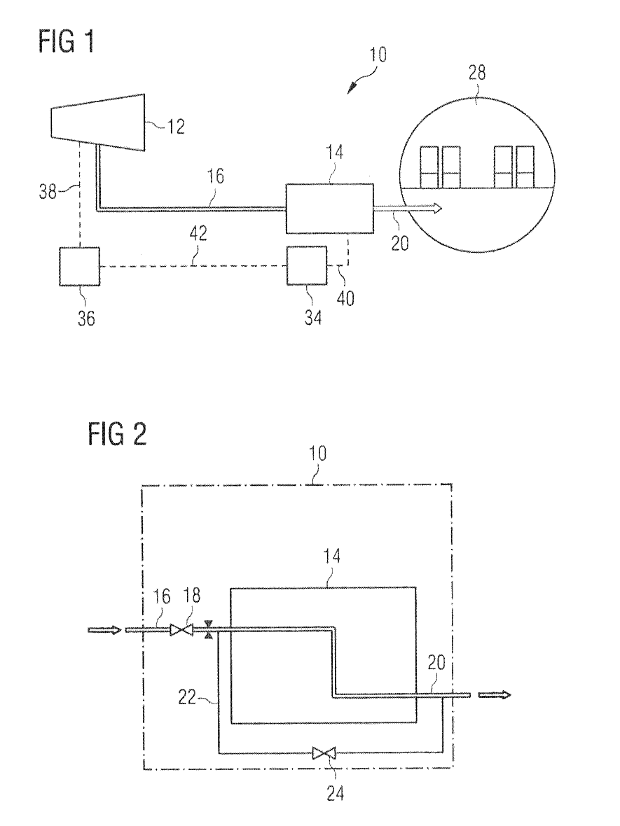

FIG. 1 shows an aircraft air conditioning system 10, which, during ground operation of the aircraft, is supplied with compressed process air from an auxiliary power unit 1. The compressed air generated by the auxiliary power unit 12 is supplied to the aircraft air conditioning system 10, specifically an air conditioning unit 14 of the air conditioning 10 via a line 16. As becomes apparent from FIG. 2, a valve 18 is disposed in the line 16 which controls the supply of compressed process air into the air conditioning unit 14 of the aircraft air conditioning system 10. In the air conditioning unit 14 the process air, upon flowing through at least one heat exchanger and upon flowing through various compression and expansion units, is cooled and expanded.

Cool process air exits the air conditioning unit 14 via a further line 20. A bypass line 22 branches off from the line 16 upstream of the air conditioning unit 14 and opens into the line 20 downstream of the air conditioning unit 14. A bypass valve 24 is disposed in the bypass line 22. Hot process air bled off the auxiliary power unit 12, via the bypass line 22, may bypass the air conditioning unit 14 and may be mixed with the cool air exiting the air conditioning unit 14 downstream of the air conditioning unit 14. Thus, by appropriately controlling the bypass valve 14, the temperature of the process air at the exit of the air conditioning unit 14 may be controlled as desired.

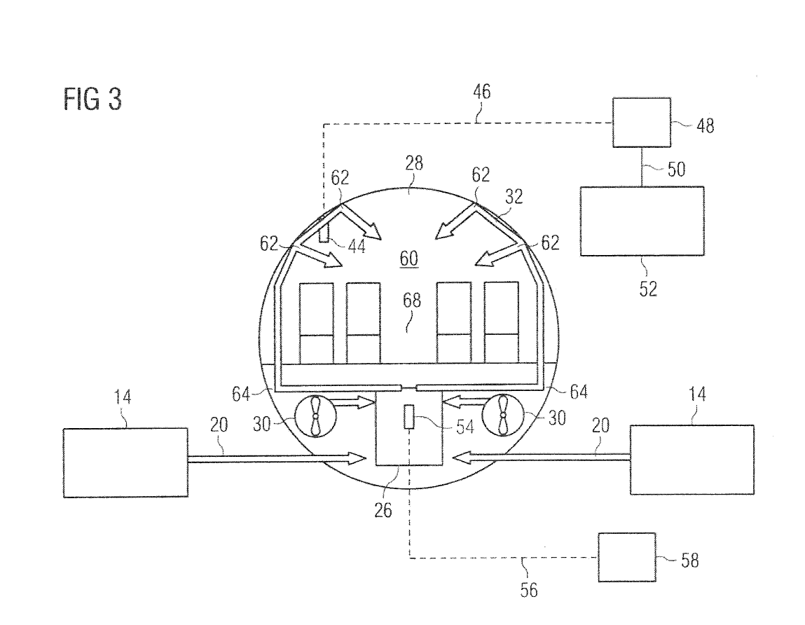

As depicted in FIG. 3, via the further line 20, compressed air, which may be a mixture of air cooled and expanded by the air conditioning unit 14 and hot compressed air which is supplied to the air cooled in the air conditioning unit 14 via the bypass line 22, is guided into a mixing chamber 26. In the mixing chamber 26 the compressed air is mixed with recirculation air discharged from an aircraft region 28 to be air conditioned by means of recirculation fans 30. Mixed air from the mixing chamber 26 finally is supplied to the aircraft region 28 to be air conditioned via an air distribution system 32.

The operation of the aircraft air conditioning system 10 is controlled by means of an electronic control unit 34. An electronic control unit 36 serves to control the operation of the auxiliary power unit 12. A first signal line 38 connects the control unit 36 for controlling the auxiliary power unit 12 to the auxiliary power unit 12. A second signal line 40 connects the electronic control unit 34 for controlling the air conditioning system 10 to the air conditioning unit 14. Further, the electronic control unit 34 is connected to the recirculation fans 30 and adapted to control the operation of the recirculation fans 30. Moreover, the electronic control unit 34 is connected to the bypass valve 24 and adapted to control the operation of the bypass valve 24. Finally, the control units 34, 36 communicate with each other via a third signal line 42.

As becomes apparent from FIG. 3, a temperature sensor 44 is disposed in the aircraft region 28 to be air conditioned, which, via a fourth signal line 46, provides signals indicative of the actual temperature in the aircraft region 28 to be air conditioned to an electronic control unit 48. The electronic control unit 48, via a fifth signal line 50, is connected to an input device 52. Upon start-up of the aircraft air conditioning system 10 the electronic control unit 48 determines a heating or cooling demand of the aircraft region 28 to be air conditioned. For determining the heating or cooling demand of the aircraft region 28 to be air conditioned, the electronic control unit 48 may, for example, compare an actual temperature in the aircraft region 28 to be air conditioned with a set temperature in the aircraft region 28 to be air conditioned. The actual temperature in the aircraft region 28 to be air conditioned may be measured by means of the temperature sensor 44 which is disposed in the aircraft region 28 to be air conditioned. The set temperature in the aircraft region 28 to be air conditioned may, for example, be input by a user via the input device 52 or may be stored in a storage device of the electronic control unit 48.

A further temperature sensor 54 is disposed in the mixing chamber 26 of the air conditioning system 10. A sixth signal line 46 connects the temperature sensor to an electronic control unit 58. Based on the heating or cooling demand of the aircraft region 28 to be air conditioned, which is communicated to the electronic control unit 58, the electronic control unit 58 determines a set temperature of the mixed air in the mixing chamber 26. Further, the electronic control unit 58 compares the set temperature of the mixed air in the mixing chamber 26 with the actual temperature of the mixed air in the mixing chamber 26 which is measured by means of the temperature sensor 54.

The electronic control unit 48 and the electronic control 58 both communicate with the electronic control unit 34 of the air conditioning system 10. Based on the data provided by the electronic control units 48, 58, the electronic control unit 34 controls the operation of the air conditioning unit 14 and thus the temperature and the volume flow of cool air exiting the air conditioning unit 14. Further, the electronic control unit 34 controls the bypass valve 24 and thus the supply of hot compressed air to the cool air exiting the air conditioning unit 14. Finally, the electronic control unit 34 controls the operation of the recirculation fans 30 and thus the volume flow of recirculation air conveyed by the recirculation fans 30 from the aircraft region 28 to be air conditioned into the mixing chamber 26. The electronic control unit 34, via the third signal line 42, communicates with the electronic control unit 36 of the auxiliary power unit 12 which controls the operation of the auxiliary power unit 12 in dependence on the data provided by the electronic control unit 34 of the air conditioning system 10.

It should be noted that the above described distribution of control tasks to different electronic control units is merely an example of how the air conditioning system 10 and the auxiliary power unit 12 may be controlled. It is, of course, also conceivable to use a smaller number of control units or only one control unit for implementing the control strategies which will be described in more detail in the following. Further, instead of signal lines, wireless data transmission may be employed.

In the exemplary embodiment described herein, the aircraft region 28 to be air conditioned by means of the air conditioning system 10 comprises a passenger cabin 60. Conditioned air from the mixing chamber 26 of the air conditioning system 10, via the air distribution system 32, is injected into the passenger cabin 60 through air inlets 62 which are arranged in a ceiling region of the passenger cabin 60. As becomes apparent from FIGS. 3 to 5, the air inlets 62 eject the conditioned air substantially in a direction of a central region of the passenger cabin 60. By means of is the recirculation fans 30, air is discharged from the passenger cabin 60 via air outlets 64 which are arranged in a floor region of the passenger cabin 60.

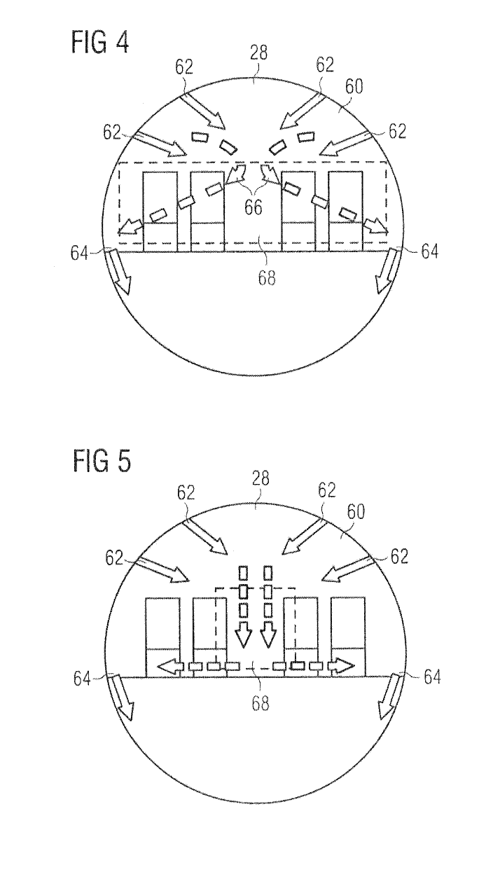

During normal operation of the aircraft, i.e. during operational phases of the aircraft during which the passenger cabin 60 is occupied with passengers, the supply of conditioned air from the aircraft air conditioning system 10 to the passenger cabin 60, by means of the control unit 34, is controlled such that the conditioned air is evenly distributed in the passenger cabin 60, see FIG. 4. Specifically, the conditioned air is supplied from the mixing chamber 26 of the air conditioning system 10 to the passenger cabin 60 via the air inlets 62 at a high speed of approx. 1.5 to 2.5 m/s and thus with a high impulse. As a result, tumble air movements 66 form in the passenger cabin 60 which ensure a virtual homogeneous intermixing of the conditioned air with the ambient air, wherein free convection induced by heat sources and cold or hot surfaces is dominated by the forced flow of the tumble air movements 66. Due to the tumble air movements 66 the conditioned air is evenly distributed in the aircraft region to be air conditioned.

By contrast, during a maintenance operational phase of the aircraft during which maintenance or service work may be performed or the aircraft may be cleaned, the supply of conditioned air from the aircraft air conditioning system 10 to the passenger cabin 60 is controlled by the control unit 34 such that the distribution of the conditioned air is concentrated to a selected portion of the passenger cabin 60 in which the major part of the maintenance of service work or the cleaning takes place, see FIG. 5. Specifically, during the maintenance operational phase of the aircraft, the supply of conditioned air from the aircraft air conditioning system 10 to the passenger cabin 60 is controlled such that the conditioned air is no longer evenly distributed in the passenger cabin 60, but concentrated to an aisle region 68 of the passenger cabin 60, Hence, during the maintenance operational phase of the aircraft, the air conditioning demand required to be provided by the aircraft air conditioning system 10 can be reduced as compared to the air conditioning demand required to be provided by the aircraft air conditioning system 10 during normal operation of the aircraft, while still ensuring that the aisle region 68 of the passenger cabin 60, the major working environment for maintenance workers or cleaning staff, is sufficiently air conditioned.

The control unit 34 initiates the control of the supply of conditioned air from the aircraft air conditioning system 10 to the passenger during the maintenance operational phase of the aircraft according to FIG. 5 in response to a signal indicative of the start of the maintenance operational phase of the aircraft. The signal indicative of the start of the maintenance operational phase of the aircraft is a signal that is output to the control unit 34 in response to a manual input of the maintenance or cleaning crew via the input unit 52.

The concentration of the distribution of the conditioned air to the aisle region 68 of the passenger cabin 60, during the maintenance operational phase of the aircraft, is achieved by suitably controlling the supply of conditioned air into the passenger cabin 60 via the air inlets 62. Specifically, under the control of the control unit 34, during the maintenance operational phase, the speed at which the conditioned air is ejected from the air inlets 62 and hence the impulse of the conditioned air is set to be lower than during normal operation of the aircraft, By reducing the speed and thus the impulse of the air blown into the passenger cabin 60, the formation of tumble air movements which provide for an even distribution of the conditioned air in the passenger cabin 60 is limited or even prevented. Hence, the distribution of the conditioned air supplied to the passenger cabin 60 is concentrated to the aisle region 68 of the passenger cabin 60. For example, if during normal operation of the aircraft conditioned air is supplied to the passenger cabin 60 at a speed of approx. 1.5 to 2.5 m/s and with a high impulse, during the maintenance operational phase of the aircraft said air speed to be reduced to 0.5 to 1.5 m/s. As a result, the impulse of the conditioned air injected into the passenger cabin is also reduced.

Further, if desired, the concentration of the distribution of the conditioned air to the aisle region 68 of the passenger cabin 60 may be supported by appropriately controlling an injection angle at which the conditioned air is injected into the passenger cabin 60. Specifically, the control unit 34 may control an orientation of the air inlets 62 such that the conditioned air is ejected from the air inlets 62 in the direction of the aisle region 68 of the passenger cabin 60.

Further, under the control of the control unit 34, during the maintenance operational phase of the aircraft, a lower amount of conditioned air may be supplied to the passenger cabin 60 than during normal operation of the aircraft. For example, if during normal operation of the aircraft a volume flow of conditioned air of 88 litre per meter cabin length is supplied to the passenger cabin 60, during the maintenance operational phase of the aircraft said conditioned air volume flow is reduced by 30 to 40% to 53 to 62 litre per meter cabin length. A reduction of the amount of conditioned air supplied to the passenger cabin 60 may be achieved by reducing the amount of recirculation air supplied to the mixing chamber 26 of the aircraft air conditioning system 10 from the passenger cabin 60 by appropriately reducing the speed of the recirculation fans 30. Alternatively or additionally thereto, the amount of fresh air provided by the air conditioning unit 14 of the air conditioning system 10 and/or via the bypass line 22 to the mixing chamber 26 may be reduced.

During normal operation of the aircraft the temperature of the conditioned air supplied to the passenger cabin 60 should not fall below a predetermined threshold value so as to ensure a high air conditioning comfort in the passenger cabin 60. During the maintenance operational phase of the aircraft it is, however, not necessary that these comfort requirements are met. Therefore, during the maintenance operational phase of the aircraft, the conditioned air supplied to the passenger cabin 60 may be controlled, by the control unit 34, so as to have a lower temperature than during normal operation of the aircraft. This may be achieved by reducing the percentage of typically relatively warm recirculation air in the mixing chamber 26 by appropriately controlling the recirculation fans 30. Alternatively or additionally thereto, the temperature of the fresh air supplied to the mixing chamber 26 via the line 20 may be reduced. A reduction of the temperature of the air supplied to the mixing chamber 26 via the line 20 may be achieved by closing the bypass valve 24 or by increasing the cooling performance of the air conditioning unit 14. For example, if during normal operation of the aircraft the temperature of the conditioned air supplied to the passenger cabin 60 is 10 to 20° C., during the maintenance operational phase of the aircraft the temperature of the conditioned air supplied to the passenger cabin 60 is reduced to 3 to 8° C.

During the maintenance operational phase of the aircraft the supply of conditioned air to the passenger cabin 60 may be controlled in dependence on the air conditioning state in the aisle region 68 of the passenger cabin 60. For example, signals provided by suitable sensors, such as temperature sensors or pressure sensors disposed in the aisle region 68 of the passenger cabin 60 (not shown in the drawings), may be used upon controlling the supply of conditioned air to the passenger cabin 60.

1. A method for controlling an aircraft air conditioning system, the method comprising the steps:
during normal operation of the aircraft, controlling the supply of conditioned air from the aircraft air conditioning system to an aircraft region to be air conditioned such that the conditioned air is evenly distributed in the aircraft region to be air conditioned, and
during a predetermined operational phase of the aircraft, controlling the supply of conditioned air from the aircraft air conditioning system to the aircraft region to be air conditioned such that the distribution of the conditioned air is concentrated to a selected portion of the aircraft region to be air conditioned.

2. The method according to claim 1,
wherein the predetermined operational phase of the aircraft is a maintenance operational phase of the aircraft and the selected portion of the aircraft region to be air conditioned comprises an aisle region of the aircraft region to be air conditioned.

3. The method according to claim 1,
wherein the control of the supply of conditioned air from the aircraft air conditioning system to the aircraft region to be air conditioned during the predetermined operational phase of the aircraft is initiated in response to a signal indicative of the start of the predetermined operational phase of the aircraft, said signal being output to the aircraft air conditioning system in response to a manual input by a user and/or in response to the detection of selected operating parameters of the aircraft.

4. The method according to claim 1,
wherein conditioned air is supplied to the aircraft region to be air conditioned via air inlets which are arranged in a ceiling region of the aircraft region to be air conditioned, and which are adapted to blow out conditioned air substantially in a direction of a central region of the aircraft region to be air conditioned, and/or wherein air is discharged from the aircraft region to be air conditioned via air outlets which are arranged in a floor region of the aircraft region to be air conditioned.

5. The method according to claim 1,
wherein, during the predetermined operational phase of the aircraft, conditioned air is supplied to the aircraft region to be air conditioned at a lower speed than during normal operation of the aircraft.

6. The method according to claim 5,
wherein, during normal operation of the aircraft, conditioned air is supplied to the aircraft region to be air conditioned at a speed of approximately 1.5 to 2.5 m/s, and wherein, during the predetermined operational phase of the aircraft conditioned air is supplied to the aircraft region to be air conditioned at a speed of approximately 0.5 to 1.5 m/s.

7. The method according to claim 1,
wherein, during the predetermined operational phase of the aircraft, a lower amount of conditioned air is supplied to the aircraft region to be air conditioned than during normal operation of the aircraft.

8. The method according to claim 1,
wherein, during the predetermined operational phase of the aircraft, conditioned air is supplied to the aircraft region to be air conditioned at a lower temperature than during normal operation of the aircraft.

9. The method according to claim 1,
wherein, during the predetermined operational phase of the aircraft, the supply of conditioned air to the aircraft region to be air conditioned is controlled in dependence on the air conditioning state in the selected portion of the aircraft region to be air conditioned.

10. An aircraft air conditioning system comprising a control unit which is adapted to:
during normal operation of the aircraft, control the supply of conditioned air from the aircraft air conditioning system to an aircraft region to be air conditioned such that the conditioned air is evenly distributed in the aircraft region to be air conditioned, and
during a predetermined operational phase of the aircraft, control the supply of conditioned air from the aircraft air conditioning system to the aircraft region to be air conditioned such that the conditioned air is distributed only in a selected portion of the aircraft region to be air conditioned.

11. The system according to claim 10,
wherein the predetermined operational phase of the aircraft is a maintenance operational phase of the aircraft and the selected portion of the aircraft region to be air conditioned comprises an aisle region of the aircraft region to be air conditioned, and/or wherein the control unit is adapted to initiate the control of the supply of conditioned air from the aircraft air conditioning system to the aircraft region to be air conditioned during the predetermined operational phase of the aircraft in response to a signal indicative of the start of the predetermined operational phase of the aircraft, said signal being output to the aircraft air conditioning system in response to a manual input by a user and/or in response to the detection of selected operating parameters of the aircraft.

12. The system according to claim 10, further comprising
air inlets for supplying conditioned air to the aircraft region to be air conditioned, said air inlets being arranged in a ceiling region of the aircraft region to be air conditioned, and being adapted to blow out conditioned air substantially in a direction of a central region of the aircraft region to be air conditioned, and/or
air outlets for discharging air from the aircraft region to be air conditioned, said air outlets being arranged in a floor region of the aircraft region to be air conditioned.

13. The system according to claim 10,
wherein the control unit is adapted to control the supply of conditioned air to the aircraft region to be air conditioned such that, during the predetermined operational phase of the aircraft, the conditioned air is supplied to the aircraft region to be air conditioned at a lower speed than during normal operation of the aircraft, wherein the control unit is, in particular, adapted to control the supply of conditioned air to the aircraft region to be air conditioned such that, during normal operation of the aircraft, conditioned air is supplied to the aircraft region to be air conditioned at a speed of approximately 1.5 to 2.5 m/s, and such that, during the predetermined operational phase of the aircraft conditioned air is supplied to the aircraft region to be air conditioned at a speed of approximately 0.5 to 1.5 m/s.

14. The system according to claim 10,
wherein the control unit is adapted to control the supply of conditioned air to the aircraft region to be air conditioned such that,
during the predetermined operational phase of the aircraft, a lower amount of conditioned air is supplied to the aircraft region to be air conditioned than during normal operation of the aircraft, and/or
during the predetermined operational phase of the aircraft, conditioned air is supplied to the aircraft region to be air conditioned at a lower temperature than during normal operation of the aircraft.

15. The system according to claim 10,
wherein the control unit is adapted to control the supply of conditioned air to the aircraft region to be air conditioned during the predetermined operational phase of the aircraft in dependence on the air conditioning state in the selected portion of the aircraft region to be air conditioned.
